(19) United States
(12) Patent Application Publication
(10) Pub. No.: US 2025/0052273 A1
(43) Pub. Date: Feb. 13, 2025

(54) CONNECTING ELEMENT FOR A SUPPORTING STRUCTURE AND METHOD FOR PRODUCING THE SAME

(71) Applicants: Kamal BOUAOUAJA, Judenburg (AT); Daniel Karim BOUAOUAJA, Fohnsdorf (AT)

(72) Inventors: Kamal BOUAOUAJA, Judenburg (AT); Daniel Karim BOUAOUAJA, Fohnsdorf (AT)

(21) Appl. No.: 18/232,108

(22) Filed: Aug. 9, 2023

(51) Int. Cl. F16B 37/06; F16B 7/18

(52) U.S. Cl. CPC F16B 37/068; F16B 7/185

(57) ABSTRACT

A connecting element for a supporting structure via which at least two rods of a supporting structure can be releasably connected to the connecting element by screw connections. In order to achieve particularly efficient production, the connecting element has a base element with bores, wherein nuts are provided on the bores. A method for producing a supporting structure, which comprises at least three bars that are connected at a junction point via a connecting element by screw connections, is also provided.

The invention relates to a connecting element for a supporting structure by which at least two bars of a supporting structure can be detachably connected to the connecting element by means of screw connections.

Furthermore, the invention relates to a method for producing a supporting structure comprising at least three bars which are connected at a junction point via a connecting element by screw connections.

Supporting structures and methods for producing the same have become well known from the prior art. Generally, bars are connected at junction points, usually by welding, rivets or screws.

However, it has been shown that only low efficiency is achieved with methods known from the prior art and that the production of corresponding supporting structures is therefore only possible with a large amount of working time and thus with high costs.

This is where the invention comes in. It is the object of the invention to provide a connecting element of the type mentioned above, which enables a particularly efficient production of a corresponding supporting structure.

Furthermore, a method for producing a supporting structure of the type described above is to be provided which can be implemented particularly efficiently.

The first object is solved according to the invention by a connecting element of the type mentioned above, which has a base element with bores, wherein nuts are provided on the bores.

Within the scope of the invention, it has been recognized that efficiency in the production of corresponding supporting structures can be substantially increased if nuts are arranged in advance on the connecting element. Thus, an arrangement of the nuts at the bores can be automated and carried out in advance by machine, for example in a workshop. When assembling the supporting structure on site, it is thus only necessary to pass corresponding screws through through-holes in the bars and to connect these screws to the nuts arranged on the base element or to screw the screws into the threads of the nuts. As a result, on-site handling of the nuts is eliminated regardless of the connecting elements. Furthermore, welding or the like can also be eliminated.

The nuts are usually firmly connected to the connecting elements, for example by a form-fit, force-fit and/or firmly bonding connection.

Within the meaning of this application, the term nut is to be understood very generally as any object which has a thread into which a corresponding screw can be screwed. It is thus not mandatory, for example, that the nut is formed by a hexagon nut, although this may be a preferred embodiment.

Usually, it is provided that diameters of the individual bores are smaller than outer diameters of the nuts arranged at the respective holes. The nuts can then be supported on the base element around the hole so that, for example, when bars of a supporting structure are connected to the connecting element, the base element is arranged between a bar and the nut. A screw head of a corresponding screw, which projects through the bar and the base element into the nut, is consequently supported on the bar, optionally on a washer or the like arranged on the bar.

Usually, it is provided that diameters of the individual holes are larger than inner diameters of the nuts arranged at the respective holes. A screw which is to be screwed into the nut can then easily be passed through the holes. Usually, a diameter of the holes corresponds approximately to a nominal diameter of a screw which can be screwed into the nut as intended, or the diameter of the hole is slightly larger than this nominal diameter, so that the screw can be easily inserted into the hole while a surface contact between nut and base element is sufficiently large to avoid impermissibly high surface pressures.

It is particularly preferred that the nuts are fastened to the base element in alignment with the bores, in particular laterally on the base element. With appropriate selection of a diameter of the hole, a maximum contact surface between nut and base element is then achieved to allow a robust connection.

Preferably, the nuts are formed by press nuts which are pressed into the base element. This ensures a simple producibility, especially since the nuts can also be pressed into the base element at the holes in an automated process.

In principle, the base element can be produced in a wide variety of ways. Particularly preferably, it is provided that the base element is formed by laser cutting from a plate-shaped component, which in particular consists of a metal, preferably a steel. Typically, the base element has a plate thickness of at least 4 mm. As an alternative to a steel, the base element can of course also be formed by an aluminum plate or another metal.

It is beneficial if the base element is galvanized. This effectively prevents corrosion.

In the case of a supporting structure which has at least three bars which are connected at a junction point via a connecting element by screw connections, it is preferably provided that the connecting element is designed according to the invention. The corresponding supporting structure can then be manufactured in a particularly simple manner.

Preferably, it is provided that the bars are formed by hollow profiles. Hollow profiles, such as tubular profile steels with concentric, rectangular, oval or other closed cross-section, have a particularly high area moment of inertia and are therefore favorable for forming a stable supporting structure with low weight.

Particularly preferably, it is provided that the bars are formed by square tubes. Square tubes, i.e., tubes made of any material, preferably a metal, in particular aluminum or steel, have proved to be particularly suitable for forming supporting structures according to the invention, especially since corresponding square tubes usually have two parallel side faces which can be easily connected to plate-shaped connecting elements by screw connections. Thus, when two parallel connecting elements are used, which are arranged on opposite side faces on the bar, preferably on the inside, a force can be introduced symmetrically into the bar.

A particularly simple manufacturability results if at least one hollow profile has a recess on an upper side through which the connecting element projects into the hollow profile, wherein the connecting element is connected to the hollow profile by screws, which screws project through a side face of the hollow profile. The recess can also be made in the hollow profile in advance so that on site or at a construction site, only the connecting elements have to be inserted into the recess and fixed in the hollow profile by screws to establish the connection. Since the nuts are already attached to the connecting elements, all that is needed to do this is to insert the screws through corresponding through-holes in the side faces of the hollow profile and fix them in the nuts. The side faces of the hollow profile and the base element are then usually located between the screw head on the one hand and the nut on the other hand, which nut is arranged on the base element, usually designed as a press nut and pressed into the base element.

A particularly simple and at the same time precise production results when the recess is formed by laser cutting. The connecting element and the bars can then be prepared in a simple and at the same time reliable manner by laser cutting, preferably using a laser cutting system.

Preferably, it is provided that the hollow profile has through-holes in the side faces which correspond to holes and nuts on the connecting elements, wherein the hollow profile is connected to the connecting elements by screws which extend through the through-holes and are connected to the nuts at the holes.

Preferably, it is provided that all holes or through-holes on both the hollow profile and the connecting elements are formed by laser cutting. By laser cutting, the corresponding openings or holes can be made with high precision, so that an appropriate corresponding arrangement on the bars on the one hand and on the connecting elements on the other hand can be ensured.

It may be provided that at least two connecting elements are provided on opposite side faces of the hollow profile, which connecting elements project into the hollow profile and are each connected to the hollow profile via screws. This ensures symmetrical force transmission from the connecting elements to the bars. In this manner, several bars formed by hollow profiles, in particular square tubes, can also be connected in a simple manner by connecting two connecting elements, which are parallel, to each of the individual bars. In doing so, the connecting elements can project into the hollow profiles through a recess on an upper side or project into the hollow profiles at the ends through open end faces in order to be screwed to the hollow profiles.

For example, it can be provided that the connecting elements are connected to at least one further bar which is formed by a hollow profile, wherein the connecting elements project into an interior of the bar at an open end face of the further bar and are connected to side faces of this bar. It is thus not necessary in the case of this further bar to provide a recess in a side face or an upper face or a lower face of the bar; rather, the connecting elements can be inserted into an interior of the bar via an open end face and screwed to side faces thereof again via through-holes on the side faces of the bar, which correspond to holes and nuts on the connecting element.

Preferably, the connecting element thus has coupling regions for forming corresponding junction points, which coupling regions extend in directions corresponding to directions along which the individual bars extend away from the junction point.

It is particularly beneficial if all bars are formed by square tubes to ensure beneficial producibility.

Usually, all square tubes also have the same cross-section, so that they can be easily screwed together by means of aligned, plate-shaped connecting elements arranged on inner sides of the square tubes.

Preferably, it is provided that the nuts on the connecting elements are formed by press nuts which are pressed into the connecting elements.

The further object is achieved according to the invention by a method of the kind mentioned at the beginning, in which the connecting element is formed by providing a base element with bores, after which nuts are arranged at the bores, after which the rods are fastened to the connecting element with screws, which are screwed into the nuts.

As a result of the advance arrangement of the nuts at the holes thus achieved, a process step is thus transferred from the construction site to a production of the connecting elements, which can be carried out automatically in advance, for example in a production hall. This ensures a simplified production. Typically, a supporting structure according to the invention is produced using a method according to the invention.

Preferably, it is provided that the base element is cut out of a plate-shaped component by laser cutting.

In principle, the nuts can be connected to the base element in any desired manner, for example by bonding, welding or the like. Particularly simple production is achieved if the nuts are pressed into the base element. This can also be done in advance and automatically in a production facility. The nuts are usually formed by press nuts.

It may also be provided that the holes are made in the base element by laser cutting. This ensures a highly accurate and at the same time efficient production.

Preferably, it is provided that the connecting elements are inserted into recesses of at least some bars which are formed by hollow profiles, in particular square tubes, and are screwed into the bars with screws projecting through side faces of the bars. For this purpose, usually through-holes are provided in the side faces of the bars and corresponding holes are provided in the connecting elements, which correspond to the nuts on the connecting elements, in order to be able to achieve a connection in a simple manner by screwing in screws corresponding to the nuts after appropriate positioning of the bars and the connecting elements.

It is beneficial if connecting elements are inserted via open end faces into at least some bars formed by hollow profiles, in particular square tubes, and are screwed in place in the bars with screws projecting through side faces of the bars. The connecting elements are usually inserted, on the one hand, into recesses on the upper or lower sides of the hollow profiles and, on the other hand, into the hollow profiles via end faces of the hollow profiles in order to form corresponding junction points. Of course, it can also be provided that the connecting elements are introduced into the hollow profiles exclusively via end faces or exclusively via recesses arranged in the upper sides of the hollow profiles in order to be screwed to the inside of the hollow profiles.

Preferably it is provided that the recesses on the bars are formed by laser cutting. Accordingly, both the through-holes on the bars and the holes on the base element are preferably also formed by laser cutting.

Further features, advantages and effects of the invention will be apparent from the exemplary embodiment illustrated below. In the drawings, to which reference is made:

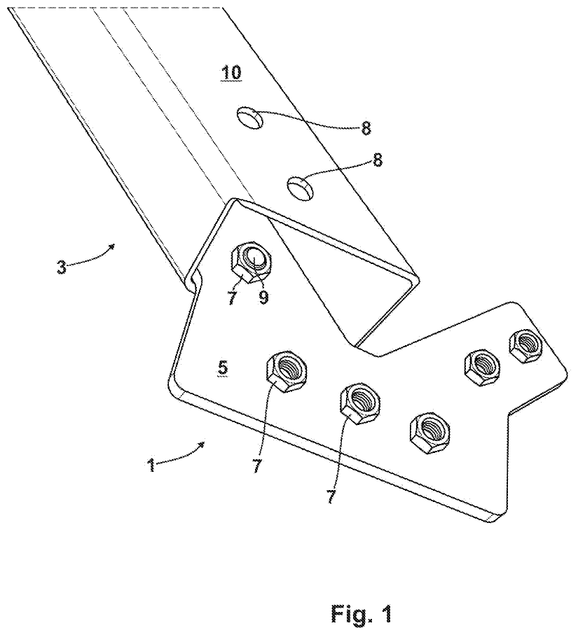

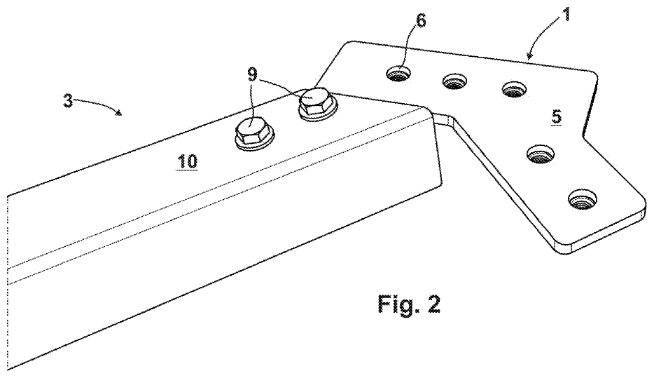

FIGS. 1 and 2 show a bar and a connecting element;

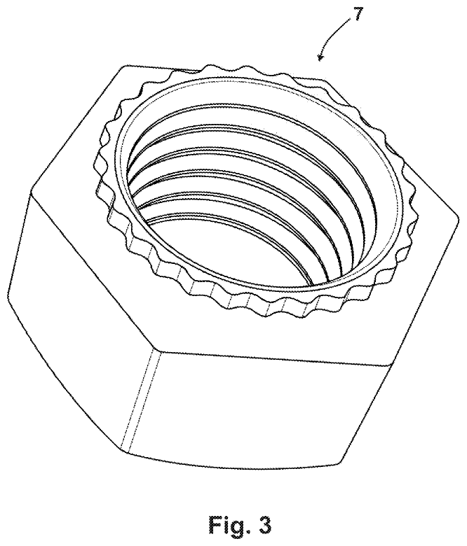

FIG. 3 shows a nut;

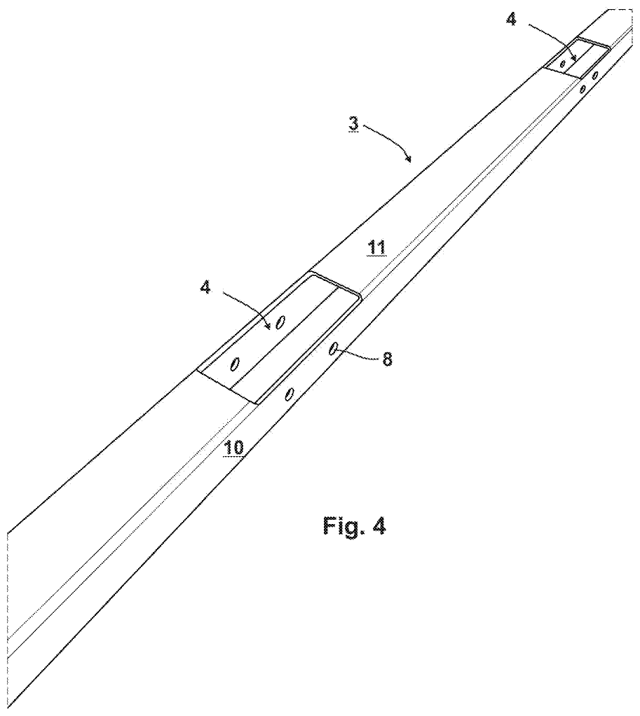

FIG. 4 shows a bar;

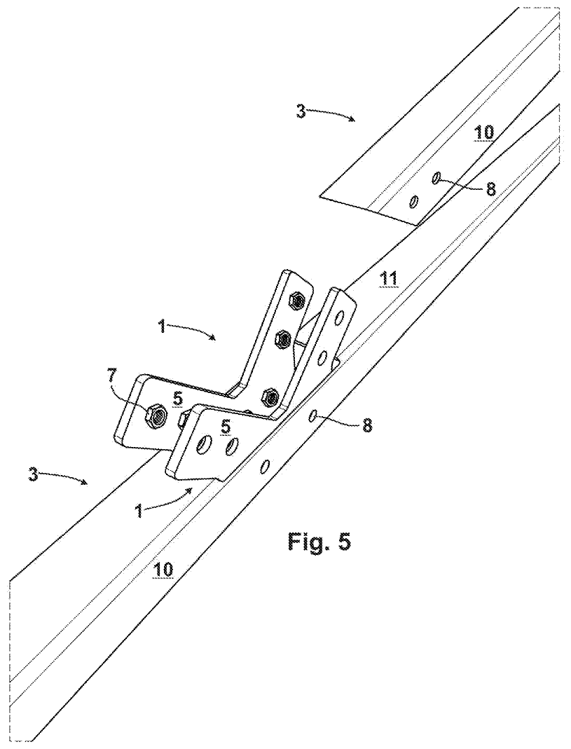

FIG. 5 shows two bars and two connecting elements of a supporting structure according to the invention;

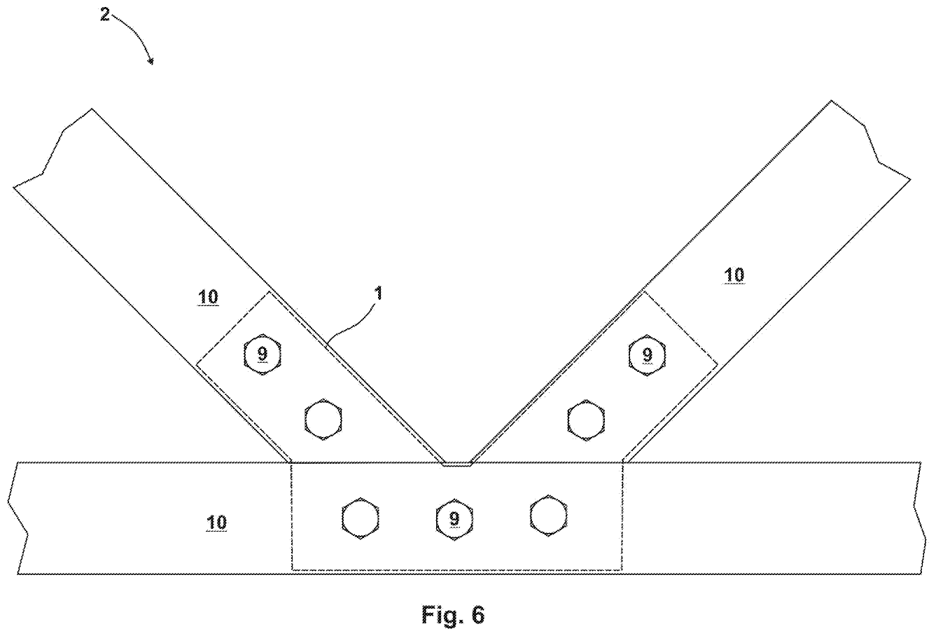

FIG. 6 shows a detail of a supporting structure according to the invention;

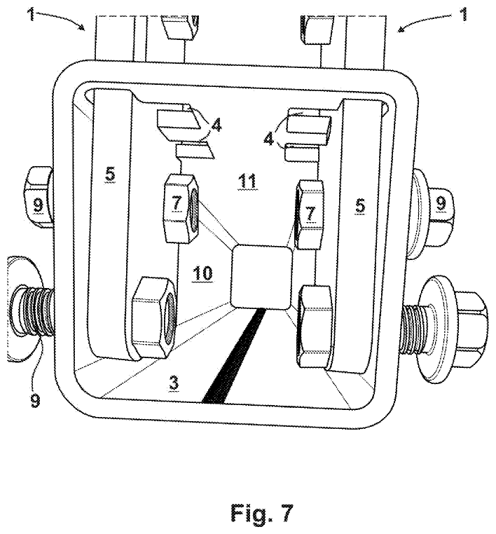

FIG. 7 shows another detail of a supporting structure according to the invention;

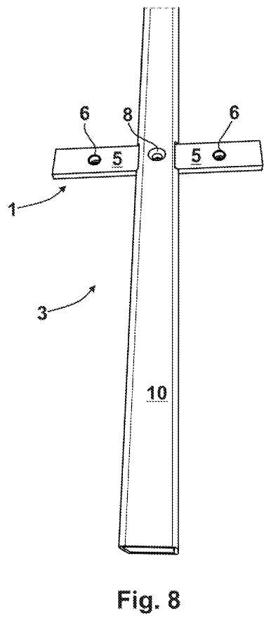

FIGS. 8 to 10 show different process steps when connecting bars of a supporting structure according to the invention.

FIGS. 1 and 2 each show a bar 3 formed by a square tube and a connecting element 1 of a supporting structure 2 according to the invention. As can be seen, the connecting element 1 has a plate-shaped base element 5 consisting of a metal, preferably steel or aluminum, and seven press nuts arranged thereon and pressed in, so that the square profile, after arrangement of the connecting element 1 in an interior of the square profile, can be screwed to the connecting element 1 via through-holes 8 in the square profile on the one hand and holes 6 in the base element 5 on the other hand, which are arranged at corresponding positions and coaxial with the nuts 7. For this purpose, a screw 9 is simply passed through the square profile from the outside and screwed into the nut 7 arranged on the base element 5, resulting in a load-bearing, force-fitting connection between the connecting element 1 and the bar 3.

The dimensions of the connecting element 1 correspond to the internal dimensions of the square tube, so that inserting the connecting element 1 into the square tube results in a flat contact, as illustrated.

In FIGS. 1 and 2, a bar 3 connected to the connecting element 1 is illustrated. It is understood that a second corresponding bar 3 and a third corresponding bar 3 can be connected to the connecting element 1 via the nuts 7 arranged on the connecting element 1 to form a junction of a supporting structure 2.

The connecting element 1 shown has three coupling regions so that a junction point connecting three bars 3 of a supporting structure 2 can be formed. It is shown in FIGS. 1 and 2 that a coupling region of the connecting elements 1 is inserted into an end face of a bar 3. A further coupling region is also designed for end-face connection to a further bar 3. A third coupling region is designed for insertion into a bar 3 via a recess 4 on an upper side 11 and has three holes 6 with associated nuts 7 for a connection to the bar 3. The dimensions of the individual coupling regions correspond to the dimensions of the bars 3 which are to be connected via the connecting element, as can be seen from the illustrated connection of the first coupling region to a bar 3.

FIG. 3 shows a press nut of a connecting element 1 according to the invention. The press nut is usually pressed into the connecting element 1 coaxial with a corresponding hole 6, so that a stable connection between the nut 7 and the base element 5 is created, via which a connection between the connecting element 1 and the individual bars 3 can be produced.

FIG. 4 schematically shows a further bar 3 of a supporting structure 2 according to the invention, which is also designed as a square tube and has recesses 4 on an upper side 11, via which connecting elements 1 can be inserted into an interior of the bar 3. Through-holes 8 are provided here on side faces 10 of the square tube, via which connecting elements 1 inserted into the recesses 4 can be screwed to the square tube to form junction points.

FIG. 5 shows a bar 3 of a supporting structure 2 according to the invention corresponding to the bar 3 shown in FIG. 4 with two connecting elements 1 inserted into the recess 4. As can be seen, the connecting elements 1 are arranged parallel and flat on the side faces 10 of the bar 3 and, after insertion, can be easily screwed to the bar 3 by screws 9 fed from the outside. Via the parts of the connecting elements 1 projecting from the recess 4, two further bars 3, which are also formed by square tubes, can be connected to the connecting elements 1 in a corresponding manner. Such a bar 3, which also has respective through-holes 8 corresponding to holes 6 and nuts 7 of the connecting elements 1, is also shown in FIG. 5.

FIG. 6 schematically shows a junction point of a corresponding supporting structure 2, wherein a connecting element 1 is again connected at a lower side to a bar 3 formed by a square tube in that the connecting element 1 is inserted into the bar 3 via a recess 4 in an upper side 11, i.e., analogous to the embodiment variant shown in FIG. 5.

Two further bars 3 are also designed as square tubes and are connected above to the connecting element 1 shown in dashed lines in that coupling regions of the connecting element 1 are inserted into these bars 3 via open end faces and are screwed to the bars 3 on the inside by screws 9 fed from outside.

FIG. 7 shows a detail of a supporting structure 2 according to the invention approximately along a longitudinal axis of a bar 3 of the supporting structure 2. It can be seen via an open end face of this bar 3, which is also designed here as a square tube, that two connecting elements 1 project through recesses 4 in an upper side 11 of the bar 3 into an interior of the bar 3, which are approximately parallel. As shown, the connecting elements 1 are connected to the bar 3 by screws 9, wherein, here too, the screws 9 project through side faces 10 of the bar 3 and are screwed in place by nuts 7, which are also formed here as press nuts and are pressed into base elements 5 of the connecting elements 1. Via the two connecting elements 1 projecting from the upper side 11 of the bar 3, a further bar 3, not shown, can be connected on two opposite side faces 10 to the illustrated bar 3 in that this further bar 3, for example, is plugged at the end face onto the parts of the connecting elements 1 projecting from the upper side 11 of the bar 3, whereupon the further bar 3 is screwed to the connecting elements 1 in an analogous manner.

As shown, the recesses 4 in the upper side 11 of the bar 3 are adapted here to a contour of the connecting elements 1 to be inserted into an interior of the bar 3, so that the recesses 4 also have cutouts for the nuts 7.

FIGS. 8 to 10 show successive process steps in a method for connecting bars 3 of a supporting structure 2 to a connecting element 1 according to the invention.

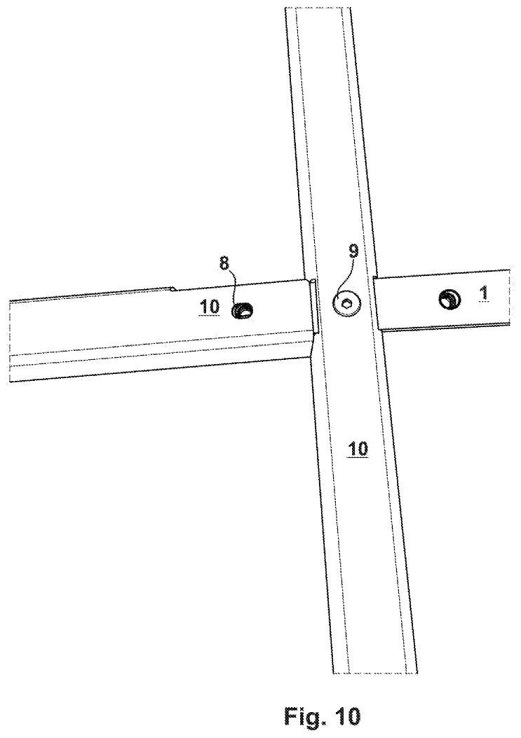

As can be seen, the bar 3 shown in FIGS. 8 to 10 has two opposing recesses 4 through which a connecting element 1 projects from both sides of the bar 3, which is also designed here as a square tube. The connecting element 1 has approximately a cuboid shape so that it can be passed from one side through both recesses 4 of the bar 3 to reach the position shown in FIG. 10. The connecting element 1 has three holes 6 and, on a lower side not shown, three nuts 7 corresponding to the holes 6, which are also designed here as press nuts and are pressed into a base element 5 of the connecting element 1.

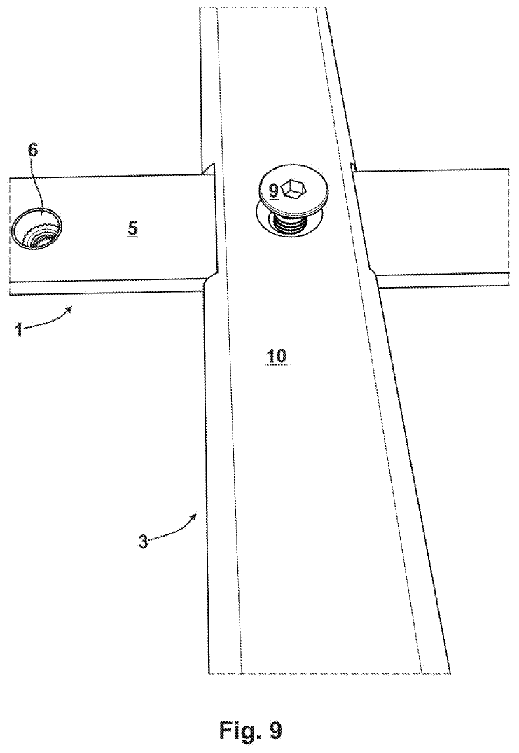

A central hole 6, at which a nut 7 is also arranged, is arranged in FIG. 8 at a position corresponding to a through-hole 8 in the bar 3, so that the bar 3 can be screwed to the connecting element 1 partially located in the bar 3 by means of a screw 9 which is inserted into the through-hole 8, as shown in FIG. 9.

In contrast to the exemplary embodiments shown in FIGS. 1 to 7, the screw 9 is designed here as a countersunk screw. Of course, embodiments with any other screw shape are also possible.

FIG. 10 shows a situation in which a further bar 3 is plugged onto a part of the connecting element 1 projecting from the bar 3 shown in FIGS. 8 and 9. This further bar 3 also has a through-hole 8 in order to be connected to the connecting elements 1 and thus to the second bar 3 by means of a screw 9 which is passed through the through-hole 8.

It is understood that a further, corresponding connecting element 1 can be provided on a lower side face 10 of the bar 3 opposite the side face 10 shown, which is located at the top here, in order to connect three bars arranged at right angles to one another via two connecting elements 1 in each case, which are arranged on opposite side faces 10 of the bars.

A connecting element 1 according to the invention allows producing the supporting structures 2 in a particularly simple and at the same time reliable manner. In particular, if the connecting elements 1 are cut to size by laser cutting and the holes 6 are made by laser cutting, high accuracy at low cost is also ensured. With a method according to the invention, corresponding supporting structures 2 can be produced in a particularly fast and at the same time robust manner.

1. A connecting element for a supporting structure via which at least two rods of a supporting structure can be releasably connected to the connecting element by screw connections, wherein the connecting element has a base element with bores, wherein nuts are provided on the bores.

2. The connecting element according to claim 1, wherein the nuts are formed by set nuts which are pressed into the base element.

3. The connecting element according to claim 1, wherein the base element is formed by laser cutting from a plate-shaped component which consists in particular of a metal, preferably a steel.

4. A supporting structure, having at least three bars which are connected at a junction point via a connecting element according to claim 1 by screw connections.

5. The supporting structure according to claim 4, wherein the rods are formed by hollow profiles, in particular by square tubes.

6. The supporting structure according to claim 5, wherein at least one hollow profile has on an upper side a recess through which the connecting element projects into the hollow profile, wherein the connecting element is connected to the hollow profile by screws, which screws project through a side face of the hollow profile, wherein the recess is preferably formed by laser cutting.

7. The supporting structure according to claim 6, wherein the hollow profile has through-bores in the side face which correspond to bores and nuts on the connecting element wherein the hollow profile is connected to the connecting element by screws which extend through the through-bores and are connected to the nuts at the bores.

8. The supporting structure according to claim 6, wherein at least two connecting elements are provided on opposite side faces of the hollow profile, which connecting elements project into the hollow profile and are each connected to the hollow profile by screws.

9. The supporting structure according to claim 4, wherein the connecting elements are connected to at least one further rod which is formed by a hollow profile, wherein the connecting elements project into an interior of the rod at an open end face of the further rod and are connected to side faces of this rod.

10. The supporting structure according to claim 1, wherein all bars are formed by square tubes.

11. A method for producing a supporting structure according to claim 4, which comprises at least three bars which are connected at a junction point via a connecting element by screw connections, wherein the connecting element is formed by providing a base element with holes, whereupon nuts are arranged at the bores, whereupon the bars are fastened to the connecting element by screws which are screwed into the nuts.

12. The method according to claim 11, wherein the base element is cut out of a plate-shaped component by laser cutting.

13. The method according to claim 11, wherein the nuts are pressed into the base element.

14. The method according to claim 11, wherein the connecting elements are inserted into recesses of at least some bars which are formed by hollow profiles, in particular square tubes, and are screwed in place in the bars by screws projecting through side faces of the bars, wherein the recesses are preferably formed by laser cutting.

15. The method according to claim 11, wherein connecting elements are inserted via open end faces into at least some bars which are formed by hollow profiles, in particular square tubes, and are screwed in place in the bars by screws projecting through side faces of the bars.
